(19) United States
(12) Patent Application Publication
(10) Pub. No.: US 2024/0191997 A1
(43) Pub. Date: Jun. 13, 2024

(54) METHOD, APPARATUS, AND SYSTEM FOR PROVIDING A SIGNED ANGLE METRIC FOR MAPMATCHING BASED ON PROBE DATA

(71) Applicant: HERE Global B.V., Eindhoven (NL)

(72) Inventors: James Adeyemi FOWE, Chicago, IL (US); Sanskar KATIYAR, Chicago, IL (US)

(21) Appl. No.: 18/077,021

(22) Filed: Dec. 7, 2022

(51) Int. Cl. G01C 21/30

(52) U.S. Cl. CPC G01C 21/30

(57) ABSTRACT

An approach provides a signed angle metric for map-matching based on probe data. The approach, for example, involves processing probe data collected from a probe device to determine a probe heading, and the probe heading indicates a direction of travel of the probe device. The approach also involves matching the probe data to a road link. The approach further involves determining a link heading of the road link. The link heading indicates a direction along which the road link is oriented. The approach further involves computing a magnitude of an h-value metric based on a difference between the probe heading and the link heading. The approach further involves determining a sign of the h-value metric based on a position of the probe heading relative to the link heading. The approach further involves providing the h-value metric comprising a combination of the magnitude and the sign as an output.

### BACKGROUND

Navigation and mapping service providers are continually challenged to provide users up-to-date digital map data. One particular area of interest is the use of probe data generated by probes such as user devices, vehicles, etc. to sense and map a road network in an environment (e.g., to support autonomous or semi-autonomous operation or other location-based applications). There are approaches to filter outliers based a distance between a probe point and a road link, or based on both a median distance and a median bearing difference between probe points and the road link, etc. However, such filtering approaches cannot distinguish probe points mismatched to a wrong road link such as at a crossing of two roads. As a result, service providers face significant technical challenges to filter probe points mismatched at a crossing.

### SOME EXAMPLE EMBODIMENTS

Therefore, there is a need for providing a new approach to filter probe points mismatched at a crossing, such as using a signed angle metric for map-matching based on probe data.

According to example embodiment(s), a method comprises processing probe data collected from a probe device to determine a probe heading. The probe heading indicates a direction of travel of the probe device. The method also comprises matching the probe data to a road link. The method further comprises determining a link heading of the road link. The link heading indicates a direction along which the road link is oriented. The method further comprises computing a magnitude of an h-value metric based on a difference between the probe heading and the link heading. The method further comprises determining a sign of the h-value metric based on a position of the probe heading relative to the link heading. The sign is either a negative sign or a positive sign. The method further comprises providing the h-value metric comprising a combination of the magnitude and the sign as an output.

According to another embodiment, an apparatus comprises at least one processor, and at least one memory including computer program code for one or more computer programs, the at least one memory and the computer program code configured to, with the at least one processor, cause, at least in part, the apparatus to process probe data collected from a probe device to determine a probe heading. The probe heading indicates a direction of travel of the probe device. The apparatus is also caused to match the probe data to a road link. The apparatus is further caused to determine a link heading of the road link. The link heading indicates a direction along which the road link is oriented. The apparatus is further caused to compute a magnitude of an h-value metric based on a difference between the probe heading and the link heading. The apparatus is further caused to determine a sign of the h-value metric based on a position of the probe heading relative to the link heading. The sign is either a negative sign or a positive sign. The apparatus is further caused to provide the h-value metric comprising a combination of the magnitude and the sign as an output.

According to another embodiment, a computer-readable storage medium carries one or more sequences of one or more instructions which, when executed by one or more processors, cause, at least in part, an apparatus to process probe data collected from a probe device to determine a probe heading. The probe heading indicates a direction of travel of the probe device. The apparatus is also caused to match the probe data to a road link. The apparatus is further caused to determine a link heading of the road link. The link heading indicates a direction along which the road link is oriented. The apparatus is further caused to compute a magnitude of an h-value metric based on a difference between the probe heading and the link heading. The apparatus is further caused to determine a sign of the h-value metric based on a position of the probe heading relative to the link heading. The sign is either a negative sign or a positive sign. The apparatus is further caused to provide the h-value metric comprising a combination of the magnitude and the sign as an output.

According to another embodiment, an apparatus comprises means for processing probe data collected from a probe device to determine a probe heading. The probe heading indicates a direction of travel of the probe device. The apparatus also comprises means for matching the probe data to a road link. The apparatus further comprises means for determining a link heading of the road link. The link heading indicates a direction along which the road link is oriented. The apparatus further comprises means for computing a magnitude of an h-value metric based on a difference between the probe heading and the link heading. The apparatus further comprises means for determining a sign of the h-value metric based on a position of the probe heading relative to the link heading. The sign is either a negative sign or a positive sign. The apparatus further comprises means for providing the h-value metric comprising a combination of the magnitude and the sign as an output.

In addition, for various example embodiments described herein, the following is applicable: a computer program product may be provided. For example, a computer program product comprising instructions which, when the program is executed by a computer, cause the computer to perform any one or any combination of methods (or processes) disclosed.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing a method of the claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing a signed angle metric for map-matching based on probe data, according to example embodiment(s);

FIGS. 2A-2B are diagrams illustrating examples of probe data and link data, according to example embodiment(s);

FIG. 3 is a diagram of components of a mapping platform capable of providing a signed angle metric for map-matching based on probe data, according to example embodiment(s);

FIG. 4 is a flowchart of a process for providing a signed angle metric for map-matching based on probe data, according to example embodiment(s);

FIGS. 5A-5B are diagrams illustrating examples of calculating h-value metrics, according to example embodiment(s);

FIGS. 6A-6B are diagrams illustrating probe data on a road link and an example historical h-value distribution, according to example embodiment(s);

FIGS. 7A-7B are diagrams illustrating probe data on a road link and an example real-time h-value distribution, according to example embodiment(s);

FIGS. 8A-8B are diagrams illustrating example user interfaces displaying road link attributes and/or h-value distributions, according to example embodiment(s);

FIGS. 9A-9B are diagrams illustrating example user interfaces displaying road link attributes and/or h-value distributions, according to example embodiment(s);

FIGS. 10A-10B are diagrams illustrating example user interfaces displaying road link attributes and/or h-value distributions, according to example embodiment(s);

FIG. 11 is a diagram illustrating an example of using map route data filtered based on signed angle metrics, according to example embodiment(s);

FIG. 12 is a diagram of a geographic database, according to example embodiment(s);

FIG. 13 is a diagram of hardware that can be used to implement an embodiment;

FIG. 14 is a diagram of a chip set that can be used to implement an embodiment; and

FIG. 15 is a diagram of a mobile terminal (e.g., handset or vehicle or part thereof) that can be used to implement an embodiment.

### DESCRIPTION OF SOME EMBODIMENTS

Examples of a method, apparatus, and computer program for providing a signed angle metric for map-matching based on probe data are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

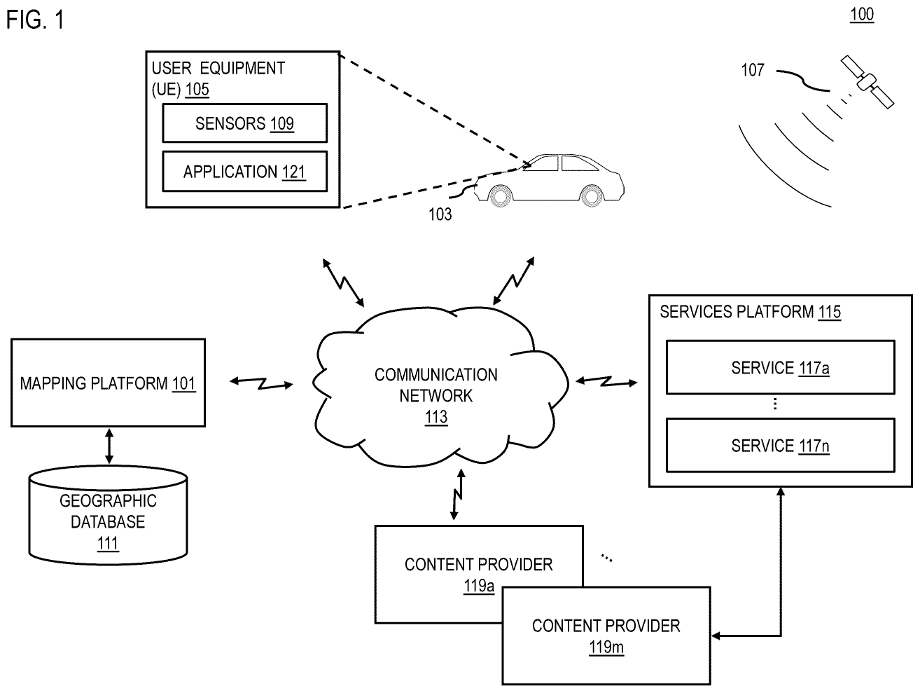

FIG. 1 is a diagram of a system capable of providing a signed angle metric for map-matching based on probe data, according to example embodiment(s). Mapping and navigation service providers (e.g., operators of a mapping platform 101) often face significant technical challenges associated with revealing or otherwise determining a route or path using probe data determined using one or more sensors 109 associated with a vehicle 103 and/or user equipment (UE) device 105 such as a satellite-based positioning system 107 or equivalent). A probe point may include the following attributes (by way of illustration and not limitation): (1) probe ID; (2) longitude; (3) latitude; (4) altitude; (5) speed; (6) bearing; and (7) time.

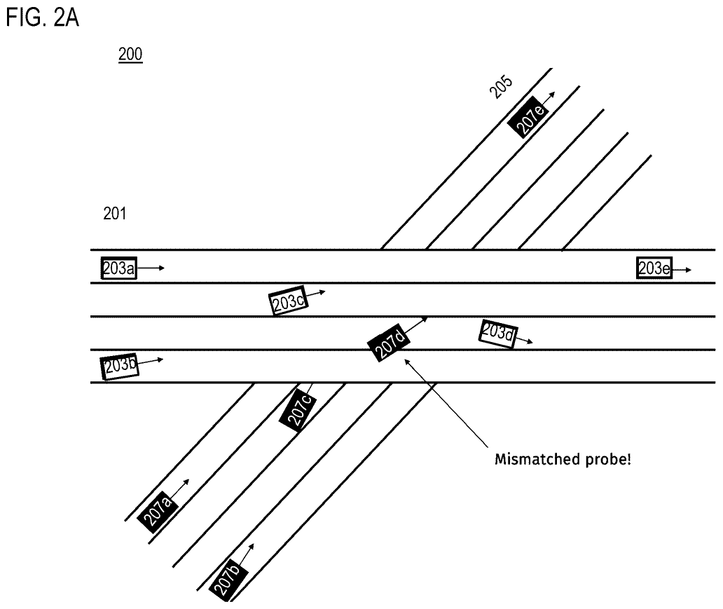

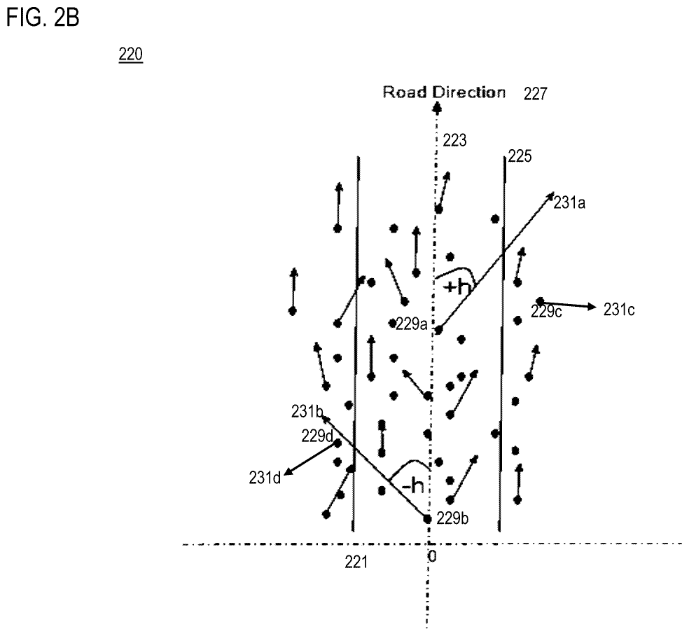

FIGS. 2A-2B are diagrams illustrating examples of probe data and link data, according to example embodiment(s). It is noted that the probe data and link data of FIGS. 2A-2B are provided by way of illustration and not as limitations. Accordingly, it is contemplated that any type of link data (e.g., any type of link-based map features, shape, object, etc.) can be used according to the various embodiments described herein. As shown a diagram 200 in FIG. 2A, probes (e.g., vehicle 203a-203e) are traveling on a road link 201 and probes (e.g., vehicle 207a-207e) are traveling on a road link 205. A road link can be referred to as a map road link of the map data.

In this case, the respective distances between vehicle 203a-203e and the road link 201 are shorter than the respective distances between vehicles 203a-203e and the road link 205, such that the existing distance filtering approach can determine the vehicles 203a-203e are travelling on the road link 201. On the other hand, the respective distances between vehicles 207a, 207b, 207c, 207e, and the road link 201 are longer than the respective distances between vehicles 207a, 207b, 207c, 207e and the road link 205, such that the existing distance filtering approach can determine the vehicles 207a, 207b, 207c, 207e are travelling on the road link 205. However, this existing distance filtering approach can mismatch the vehicle 207d as travelling on the road link 201 based on distances.

There is another approach for filtering probe data based on a product a median distance and a median bearing difference between map-matched probe points and the road link. Since this approach only evaluates the quality of a set of probe points (provided by a specific source), it cannot detect the mismatched probe point shown in FIG. 2A.

To address these technical challenges, the system 100 of FIG. 1 introduces a capability to use a signed angle metric for map-matching based on probe data. In one embodiment, the system 100 can generates a signed angle metric based on a probe heading and a road link bearing. FIG. 2B is a diagram of the bearing of a plurality of probe points with a difference from a bearing of a road link, according to example embodiment(s). The signed angle metric or the h-value metric can show the departure of a probe heading from the link bearing/direction. When the probe heading is left of the link bearing, the h-value can be negative, when it is on the right of the link bearing, then h-value can be positive.

In FIG. 2B, a link 221 has a center line 223, two boundaries 225, and a direction/bearing 227, as well as a plurality of probe points 229 with headings 231 that have been map matched to the link 221, such as a probe point 229a with a heading 231a that can be expressed as a positive angle metric +h from the link bearing 227, and probe point 229b with a heading 231b that can be expressed as a negative angle metric −h from the link bearing 227. In an example embodiment, the difference between the bearing of a respective probe point and the link bearing 227 can be a positive value between 0 degrees and 180 degrees as the respective angle extends in a clockwise direction, or a negative value between 0 degrees and −180 degrees as the respective angle extends in a counterclockwise direction. In one embodiment, the system 100 can determine a probe heading outside of thresholds, such as −90 degree and +90 degree as an outlier. For example, probe points 229c, 229d are outliers since their headings 231c, 231d are outside of −90 degree and +90 degree.

In one embodiment, the system 100 can compute the h-value metric by computing an angle between a probe vector and a link bearing using dot product, computing a relative heading direction of the probe device using cross product, and then combine the above magnitude and sign to get the h-value metric.

Referring back to FIG. 2A, as the signed angle metric of the probe point associated with the vehicle 207d is bigger than a threshold value (e.g., 45) from the link bearing of the link 221 in FIG. 2B, the system 100 can determined such probe point was mismatched to the link 201 in FIG. 2A, and should be matched to the link 205 instead.

The various embodiments of system 100 advantageously solves the technical problems related to filtering outliers and mis-matched probe points. Another advantage is that the various embodiments described herein can utilize a h-value distribution to detect lane closures/obstructions.

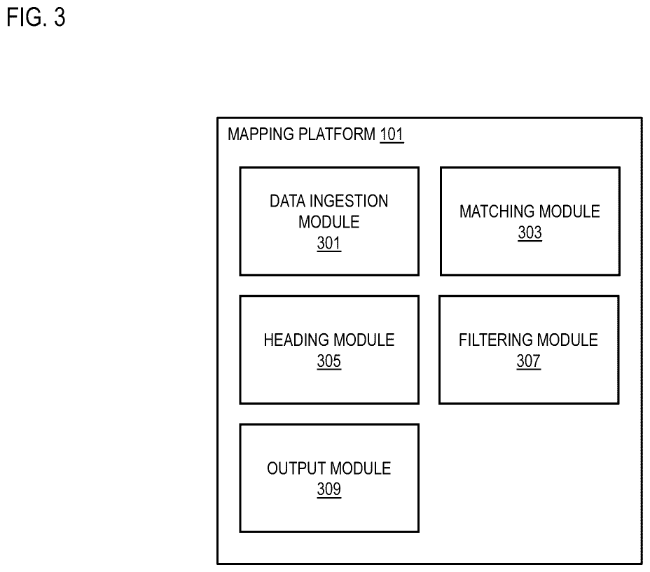

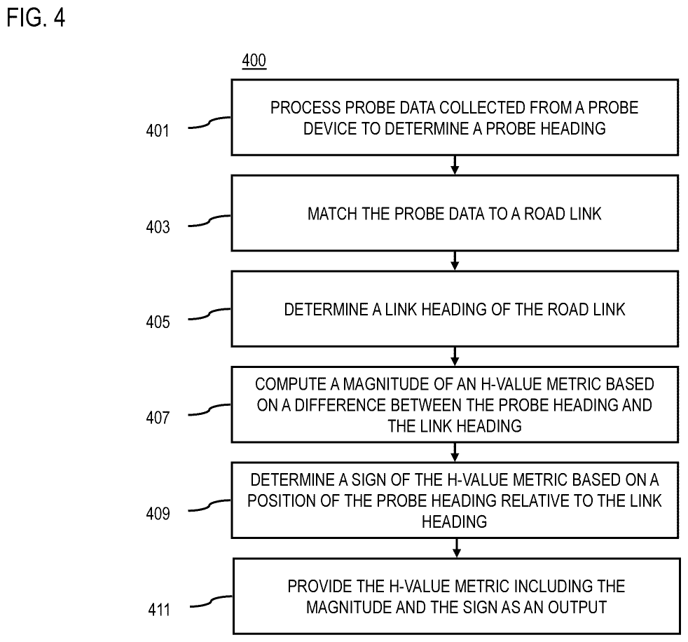

FIG. 3 is a diagram of components of the mapping platform 101 capable of providing a signed angle metric for map-matching based on probe data, according to example embodiment(s). In one embodiment, as shown in FIG. 3, the mapping platform 101 includes one or more components for processing link data according to the various embodiments described herein. As shown, in one embodiment, the mapping platform 101 includes a data ingestion module 301, a matching module 303, a heading module 305, a filtering module 307, and an output module 309. The above presented modules and components of the mapping platform 101 can be implemented in hardware, firmware, software, or a combination thereof. Though depicted as a separate entity in FIG. 1, it is contemplated that the mapping platform 101 may be implemented as a module of any of the components of the system 100 (e.g., a component of a services platform 115, one or more services 117a-117n (also collectively referred to as services 117), one or more content providers 119a-119m (also collectively referred to as content providers 119), vehicle 103, UE 105, application 121, and/or the like). In another embodiment, one or more of the modules 301-309 may be implemented as a cloud-based service, local service, native application, or combination thereof. The functions of the mapping platform 101 and modules 301-309 are discussed with respect to FIGS. 4-11 below.

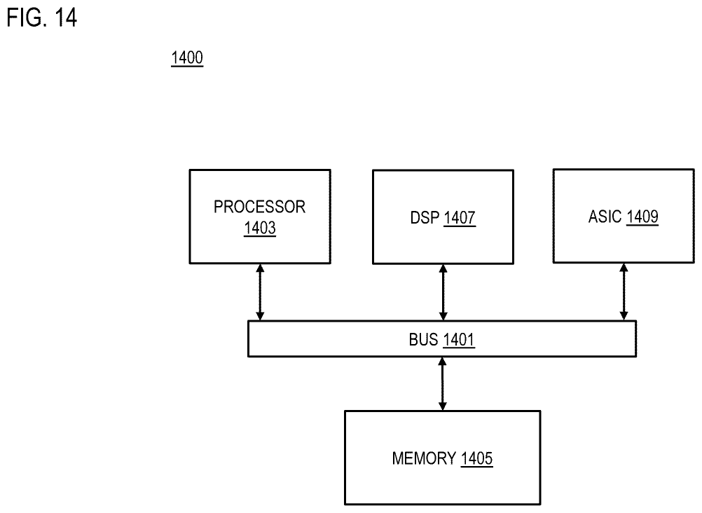

FIG. 4 is a flowchart of a process 400 for providing a signed angle metric for map-matching based on probe data, according to example embodiment(s). In various embodiments, the mapping platform 101 and/or any of the modules 301-309 may perform one or more portions of the process 400 and may be implemented in, for instance, a chip set including a processor and a memory as shown in FIG. 14. As such, the mapping platform 101 and/or any of the modules 301-309 can provide means for accomplishing various parts of the process 400, as well as means for accomplishing embodiments of other processes described herein in conjunction with other components of the system 100. Although the process 400 is illustrated and described as a sequence of steps, it is contemplated that various embodiments of the process 400 may be performed in any order or combination and need not include all of the illustrated steps.

In one embodiment, for example, in step 401, the data ingestion module 301 can process probe data (e.g., the probe point 229a in FIG. 2B) collected from a probe device (e.g., the vehicle 103, the UE 105, etc.) to determine a probe heading (e.g., the probe heading 231a in FIG. 2B), and the probe heading can indicate a direction of travel of the probe device.

In one embodiment, in step 403, the marching module 303 can match the probe data to a road link (e.g., the link 221 in FIG. 2B). In one embodiment, the line represented in the link data is a lane marking of a road represented by a map road link (e.g., stored in the digital map data of a geographic database 111). A “map road link” refers to a map representation of a road or road segment stored as a road link data record of the geographic database 111 or equivalent digital map. In one embodiment, the map road link includes one or more shape points that can help to define the shape of map road link to more closely match the corresponding real world road segment. The one or more shape points are positioned at respective points along the map road link to delineate a plurality of link segments of the map road link. Each link segment defined by the shape points can have different headings to represent different contours of the road. The one or more location data points can then be matched to respective link segments of the plurality of link segments (as opposed to matching against the entire map road link which can provide a coarser representation of the actual road). In this way, the map link heading, the line representation (e.g., centerline) of the map road link, or a combination thereof can be determined with respect based on the respective link segments for providing a signed angle metric for map-matching based on probe data.

In one embodiment, in step 405, the heading module 305 can determine a link heading (e.g., the link heading 227 in FIG. 2B) of the road link, and the link heading can indicate a direction along which the road link is oriented. In one embodiment, the sign of the h-value metric can be the negative sign based on determining that the position of the probe heading (e.g., the probe heading 231b in FIG. 2B) is to a left of the link heading (e.g., the link heading 227 in FIG. 2B), and the sign of the h-value metric can be the positive sign based determining that the position of the probe heading (e.g., the probe heading 231a in FIG. 2B) is to a right of the link heading (e.g., the link heading 227 in FIG. 2B).

In one embodiment, in step 407, the heading module 305 can compute a magnitude of an h-value metric based on a difference between the probe heading and the link heading. In one embodiment, in step 409, the heading module 305 can determine a sign of the h-value metric based on a position of the probe heading relative to the link heading, and the sign can be either a negative sign or a positive sign.

For instance, the heading module 305 can generate a probe heading unit vector \vec{A} based on the probe heading (using e.g., Equation (1)) and a link heading unit vector B based on the link heading (using e.g., Equation (2)), the magnitude θ of the h-value can be computed using a dot product of the probe heading unit vector and the link heading unit vector (using e.g., Equation (3)), and the sign of the h-value can be determined using a cross product of the probe heading unit vector and the link heading unit vector (using e.g., Equation (4)).

Input: probe heading θₐ, link bearing θ_{b} in degrees using true north or magnetic north as a reference. The h-value metric can comprise a combination of the magnitude and the sign as an output (using e.g., Equation (5)).

$$\vec{A} = ( sin {θ}_{a} ) \hat{ι} + ( cos {θ}_{a} ) \hat{J} \qquad ( 1 )$$

$$\vec{B} = ( sin {θ}_{b} ) \hat{ι} + ( cos {θ}_{b} ) \hat{J} \qquad ( 2 )$$

$$θ = {cos}^{- 1} \frac{\vec{A} \cdot \vec{B}}{\vert \vec{A} \vert \vert \vec{B} \vert} \qquad ( 3 )$$

$$sign = sgn ( {A}_{x} {B}_{y} + {B}_{x} {A}_{y} ) \qquad ( 4 )$$

$$h\_value = sign * θ \qquad ( 5 )$$

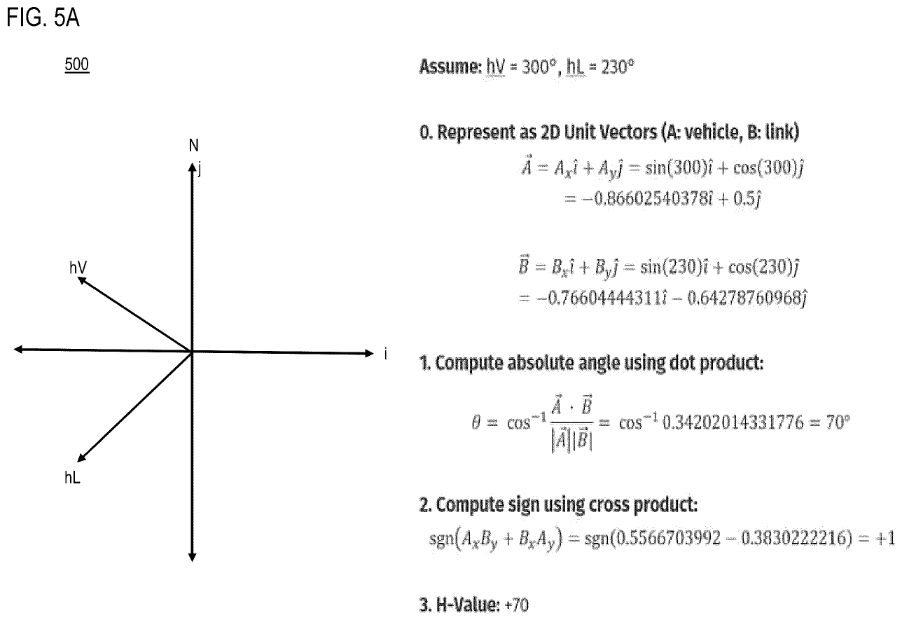

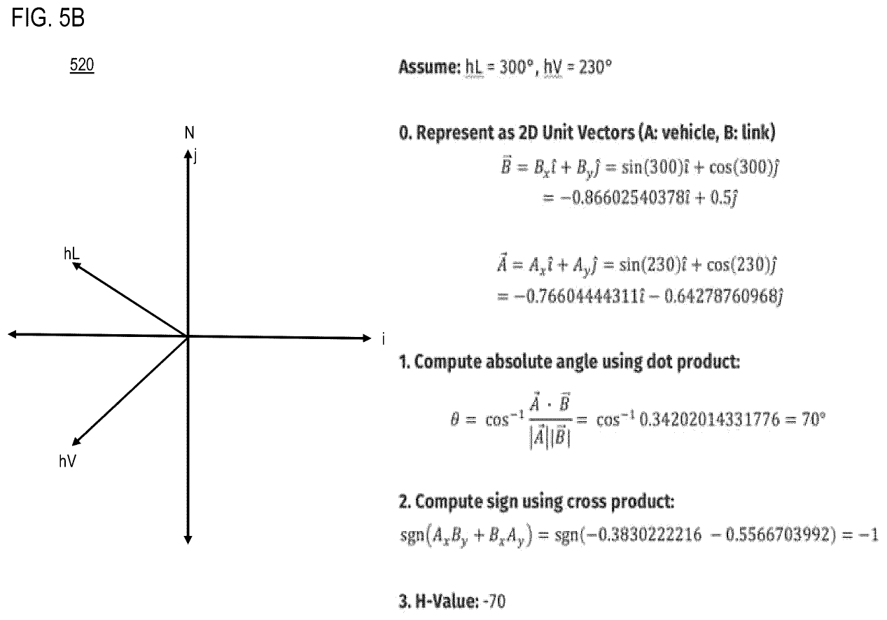

FIGS. 5A-5B are diagrams illustrating examples of calculating h-value metrics, according to example embodiment(s). In FIG. 5A, a diagram 500 shows probe heading θₐ=hV=300° and link bearing θ_{b}=hL=230°, and the h-value calculated based on Equations (1)-(5) equals to +70. In FIG. 5B, a diagram 520 shows probe heading θₐ=hV=230° and link bearing θ_{b}=hL=300°, and the h-value calculated based on Equations (1)-(5) equals to −70.

In one embodiment, the filtering module 307 can filter the probe data, determine that the probe data is a mismatch (e.g., the probe point associated with the vehicle 207d in FIG. 2A) or an outlier (e.g., the probe points 229c, 229d in FIG. 2B) for the road link, or a combination thereof based on comparing the h-value metric to a value range threshold (e.g., h-value<−90 or >+90). The marching module 303 can then perform map matching based on the filtering of the probe data, the determining that the probe data is the mismatch or the outlier, or a combination thereof.

In one embodiment, in step 411, the output module 309 can provide the h-value metric (e.g., h-value=+70 in FIG. 5A, h-value=−70 in FIG. 5B, etc.) comprising a combination of the magnitude and the sign as an output.

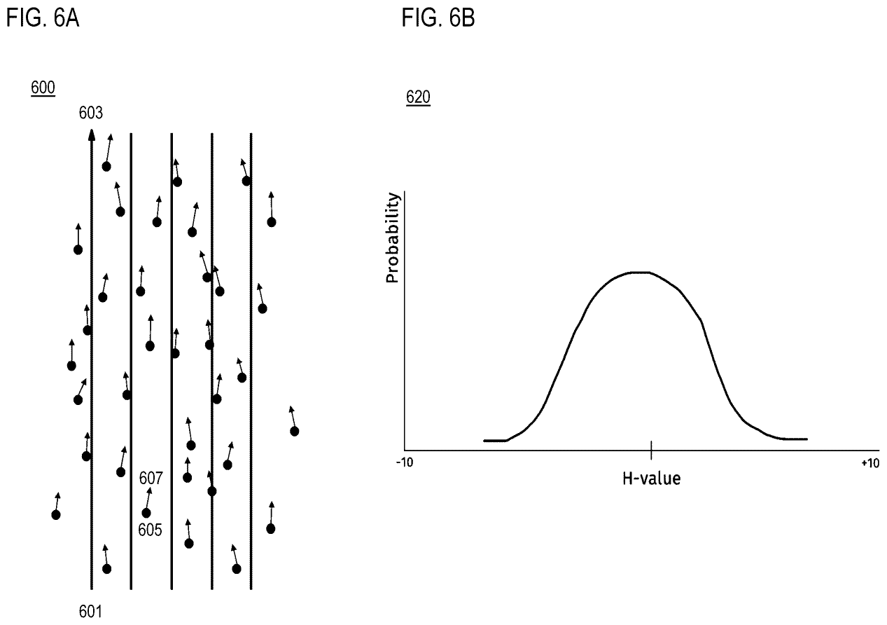

In another embodiment, the output module 309 can process real-time probe data associated with the road link to determine a distribution of real-time h-value metrics for the road link, and store the distribution of the real-time h-value metrics as a real-time artifact data record of a geographic database. FIGS. 6A-6B are diagrams illustrating probe data on a road link and an example historical h-value distribution, according to example embodiment(s). Per-link, the system 100 can maintain an artifact that represents the historical h-value distribution (e.g., a Gaussian distribution with mean centered close to 0 and a small variance to accommodate overtakes and inaccurate probe heading(s). For instance, a diagram 600 of FIG. 6A shows a link 601 has four lanes and a bearing 603, as well as a plurality of probe points 605 with headings 607 that have been map matched to the link 601. The system 100 can design/alter the historical artifact based on various applications, such as maintaining 4-hour or 1-hour h-value distribution for the day to identify recurrent traffic patterns. A diagram 620 of FIG. 6B shows a Gaussian distribution of h-values within −10 and +10 and centered close to 0.

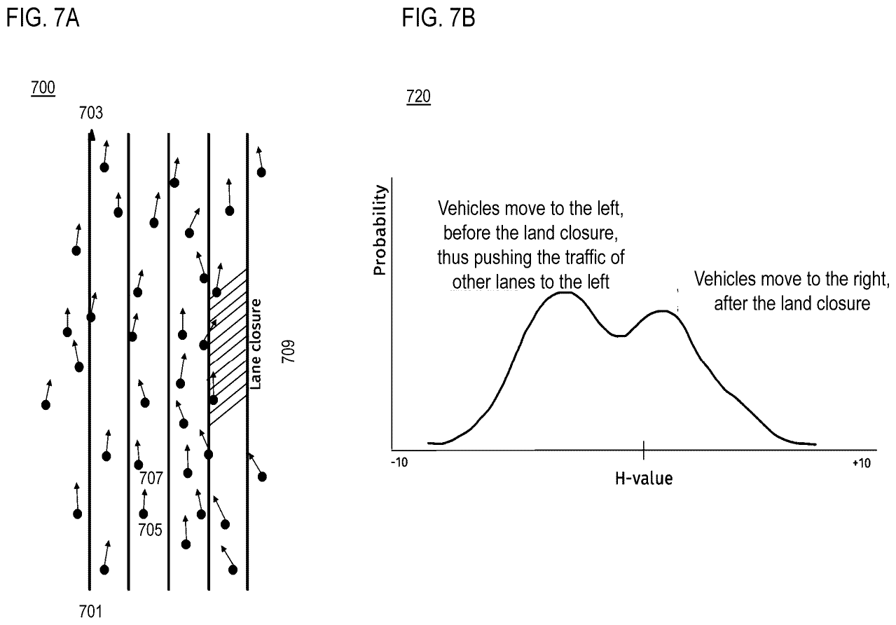

In one embodiment, the system 100 can use h-values distribution to determine a lane closure. For instance, the system 100 can monitor the probes over a 1-hour sliding window, and compute the real-time Gaussian distribution over h-values. By applying a clustering algorithm (such as multidimensional clustering, MDC), the system 100 can detect whether the distribution decomposes into multiple clusters that would support the scenario of additional maneuvers around a lane closure. In another embodiment, the system 100 can use an h-values distribution to support the findings of d-value distributions in determining lane closures. In one embodiment, a d-value of a probe point can be a distance between the probe point and the road link. Coupled with a d-value distributions per road link (e.g., similar to FIGS. 6A-6B and 7A-7B, yet based on d-values), the system 100 can make a confident assessment of a lane closure.

FIGS. 7A-7B are diagrams illustrating probe data on a road link and an example real-time h-value distribution, according to example embodiment(s). For instance, the output module 309 can detect that the distribution of the real-time h-value metrics decomposes into a plurality of clusters, and determine a traffic incident on the road link based on the plurality of clusters. By way of example, the traffic incident can relate to a lane closure or a lane obstruction on at least one lane of the road link. In one embodiment, the plurality of clusters can be determined using a multidimensional clustering (MDC) algorithm. For instance, a diagram 700 of FIG. 7A shows a link 701 has four lanes and a bearing 703, a plurality of probe points 705 with headings 707 that have been map matched to the link 701, as well as a lane closure 709. The system 100 can maintain 1-hour h-value distribution to identify current traffic pattern(s), such as vehicles moving to the left, before the land closure, thus pushing the traffic of other lanes to the left, vehicles moving to the right after the land closure, etc. A diagram 720 of FIG. 7B shows a distribution of h-values with one peak centered on a moving left h-value representing the vehicles moving to the left (before the land closure), and one peak centered on a moving right h-value representing the vehicles moving to the right (after the land closure).

In one embodiment, the system 100 apply the h-value distribution(s) to detect high occupancy vehicle (HOV) lane traffic, thereby improving HOV utilization and adjustments. For instance, transport and/or city planning authorities can add or delete HOV lane(s) on a road link based on filtered probe data (e.g., after removing outliers, mis-matched probe points).

In yet another embodiment, the output module 309 can process historical probe data associated with the road link to determine a distribution of historical h-value metrics for the road link, and store the distribution of the historical h-value metrics, the historical h-value metrics, or a combination thereof as a historical artifact data record of a geographic database (e.g., the geographic database 111). For instance, the distribution of the historical of the historical h-value metrics can be determined with respect to a sliding time window of a predetermined time duration.

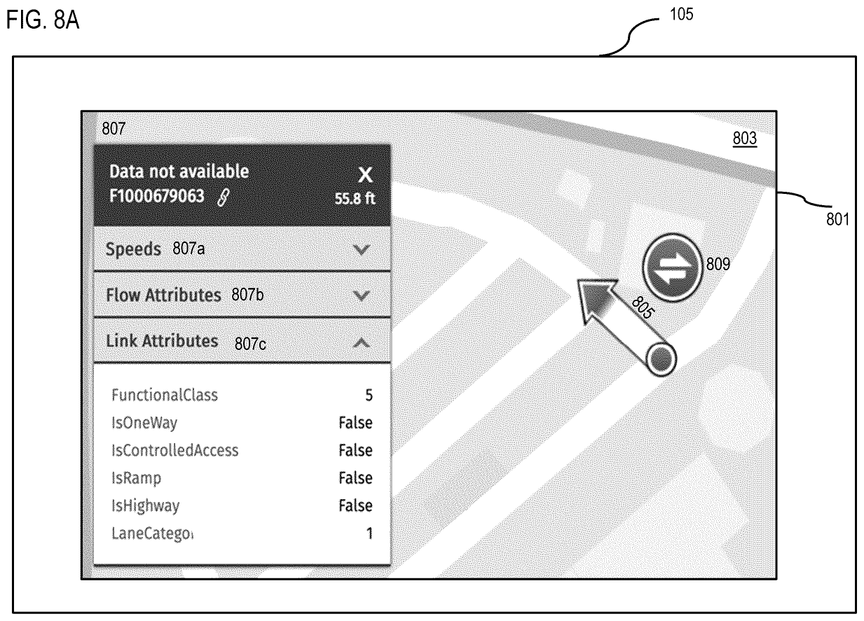

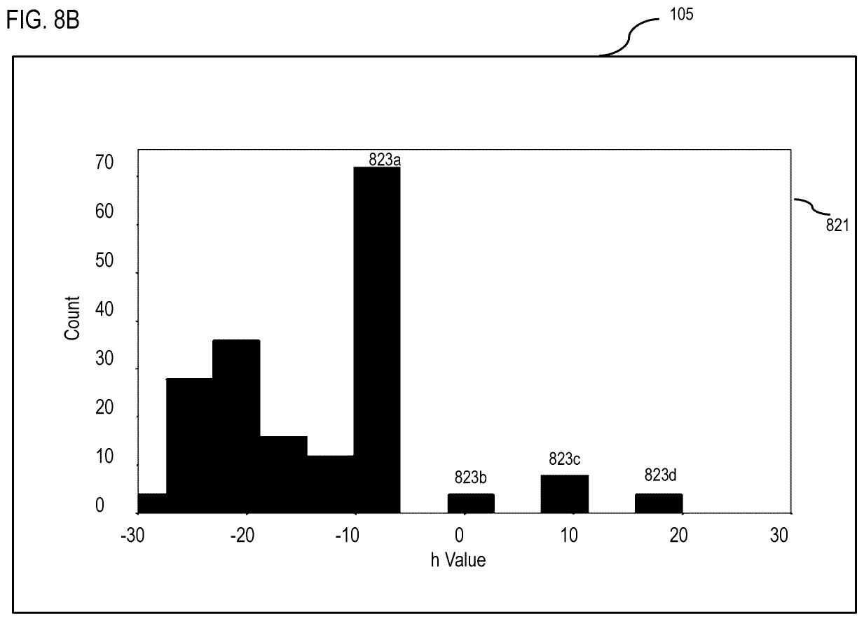

FIGS. 8A-8B are diagrams illustrating example user interfaces displaying road link attributes and/or h-value distributions, according to example embodiment(s). FIG. 8A is a diagram illustrating a user interface displaying road link attributes, according to example embodiment(s). As shown, a UE 105 supported by the system 100 that is in a vehicle 103 can display road link attributes of any road link (e.g., a road link the vehicle 103 is traveling on, or any road link of interest) on demand. In FIG. 8A, an example user interface (UI) 801 is generated for the UE 105 (e.g., a mobile device, an embedded navigation system of the vehicle 103, a server of a vehicle fleet operator, a server of a vehicle insurer, etc.). The UI 801 shows a map 803, a road link 805, and a road link attribute panel 807. In this case, the road link attribute panel 807 shows a link ID (e.g., F1000679063) and a link length (e.g., 55.8 feet), as well as a speed attribute dropdown menu 807a, a flow attribute dropdown menu 807b, and a link attribute dropdown menu 807c. Upon a user selection of the link attribute dropdown menu 807c, the road link attribute panel 807 shows: FunctionalClass as 5, InOneRoad as false, InControlledAccess as false, IsRamp as false, IsHighway as false, and LaneCategory as 1.

By way of example, LaneCategory can classify a segment based on the number of lanes in each travel direction. As another example, FunctionalClass can be defined as in Table 1.

TABLE 1
FunctionalClassType is a value of the type xs:byte. The following values
are supported:
1: a road with high volume, maximum speed traffic
2: a road with high volume, high speed traffic
3: a road with high volume traffic
4: a road with high volume traffic at moderate speeds between
neighborhoods
5: a road whose volume and traffic flow are below the level of any other
functional class

Upon a user selection of a switch 809 on the UI 801, the system 100 can switch the display a historical h-valuation distribution diagram of the road link 805 in a UI 821 in FIG. 8B. The diagram shows multiple clusters in the h-value distribution within −30 and +30. For instance, the system 100 can monitor the probes over a 1-hour sliding window, compute and cluster the real-time h-value distribution. As such, the system 100 can detect that the distribution decomposes into multiple clusters 823a-823d that would support, for example, a scenario of vehicle maneuvers around lane obstructions on the right side of the road link 805.

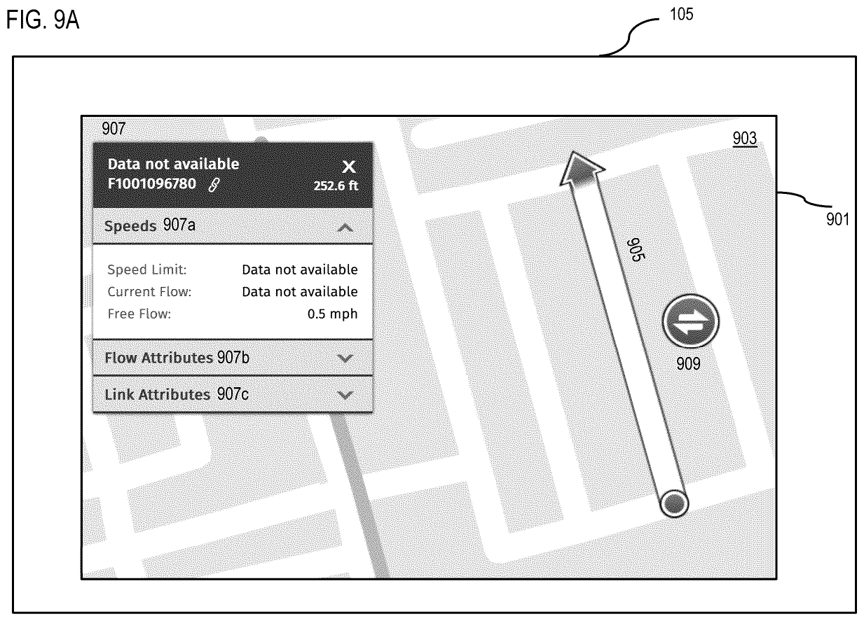

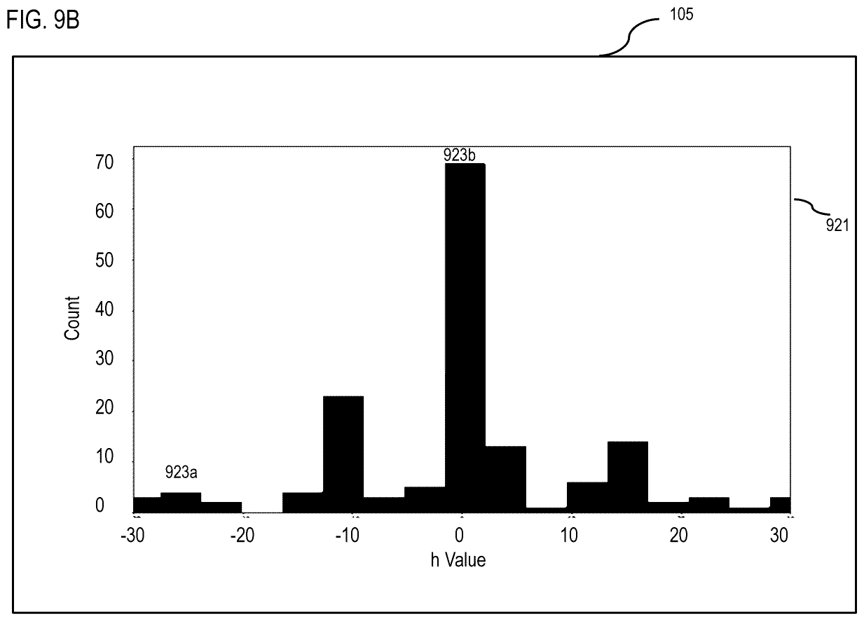

FIGS. 9A-9B are diagrams illustrating example user interfaces displaying road link attributes and/or h-value distributions, according to example embodiment(s). Similar to FIG. 8A, FIG. 9A illustrates a user interface displaying road link attributes, according to example embodiment(s). In FIG. 9A, an example user interface (UI) 901 is generated for the UE 105 to show a map 903, a road link 905, and a road link attribute panel 907. In this case, the road link attribute panel 907 shows a link ID (e.g., F1001096780) and a link length (e.g., 252.6 feet), as well as a speed attribute dropdown menu 907a, a flow attribute dropdown menu 907b, and a link attribute dropdown menu 907c. Upon a user selection of the speed attribute dropdown menu 907a, the road link attribute panel 907 shows: Speed Limit as Data not available, Current Flow as Data not available, and Free Flow as 0.5 mph.

Upon a user selection of a switch 909 on the UI 901, the system 100 can switch the display a historical h-valuation distribution diagram of the road link 905 in a UI 921 in FIG. 9B. The diagram shows multiple clusters in the h-value distribution within −30 and +30. For instance, the system 100 can monitor the probes over a 1-hour sliding window, compute and cluster the real-time h-value distribution. As such, the system 100 can detect that the distribution decomposes into multiple clusters 923a-923b that would support, for example, a scenario of vehicle maneuvers around minor lane obstructions, such as newly added lane markings.

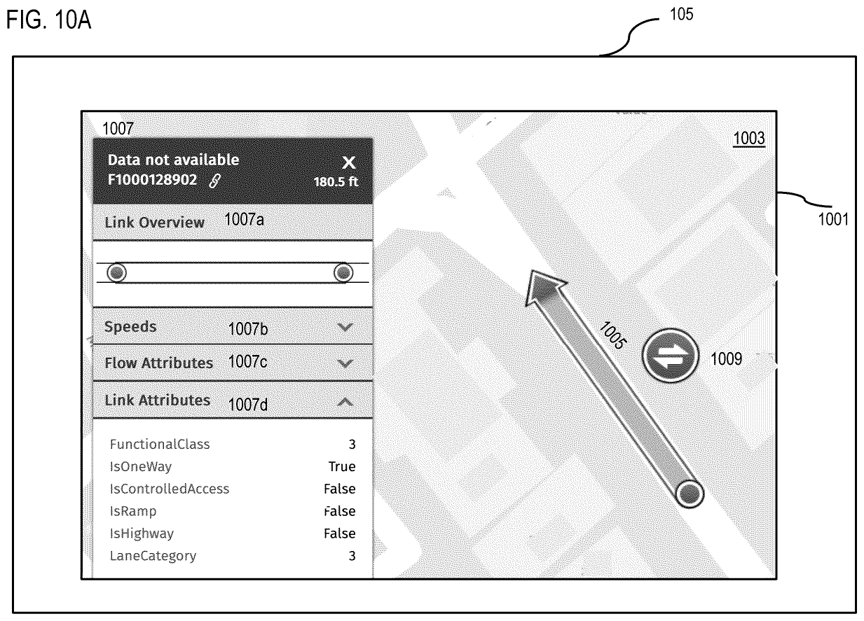

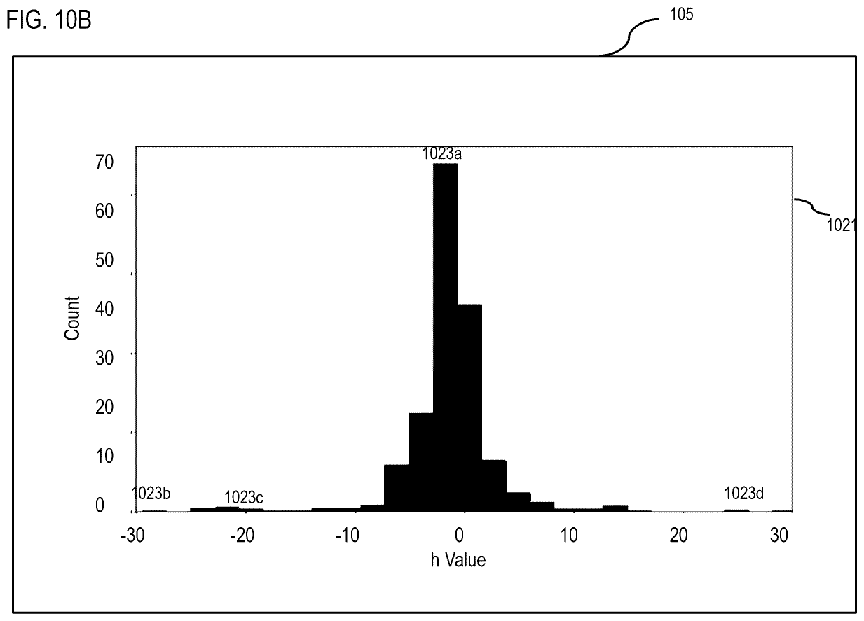

FIGS. 10A-10B are diagrams illustrating example user interfaces displaying road link attributes and/or h-value distributions, according to example embodiment(s). FIG. 10A illustrates a user interface displaying road link attributes, according to example embodiment(s). In FIG. 10A, an example user interface (UI) 1001 is generated for the UE 105 to show a map 1003, a road link 1005, and a road link attribute panel 1007. In this case, the road link attribute panel 1007 shows a link ID (e.g., F1000128902) and a link length (e.g., 108.5 feet), as well as a link overview 1007a, a speed attribute dropdown menu 1007b, a flow attribute dropdown menu 1007c, and a link attribute dropdown menu 1007d. Upon a user selection of the link attribute dropdown menu 1007d, the road link attribute panel 1007 shows: FunctionalClass as 3, InOneRoad as true, InControlledAccess as false, IsRamp as false, IsHighway as false, and LaneCategory as 3.

Upon a user selection of a switch 1009 on the UI 1001, the system 100 can switch the display a historical h-valuation distribution diagram of the road link 1005 in a UI 1021 in FIG. 10B. The diagram shows multiple clusters in the h-value distribution within −30 and +30. For instance, the system 100 can monitor the probes over a 1-hour sliding window, compute and cluster the real-time h-value distribution. As such, the system 100 can detect a single cluster 1023a and outliers 1023b, 1023c, 1023d, etc. (e.g., using standard outlier detection).

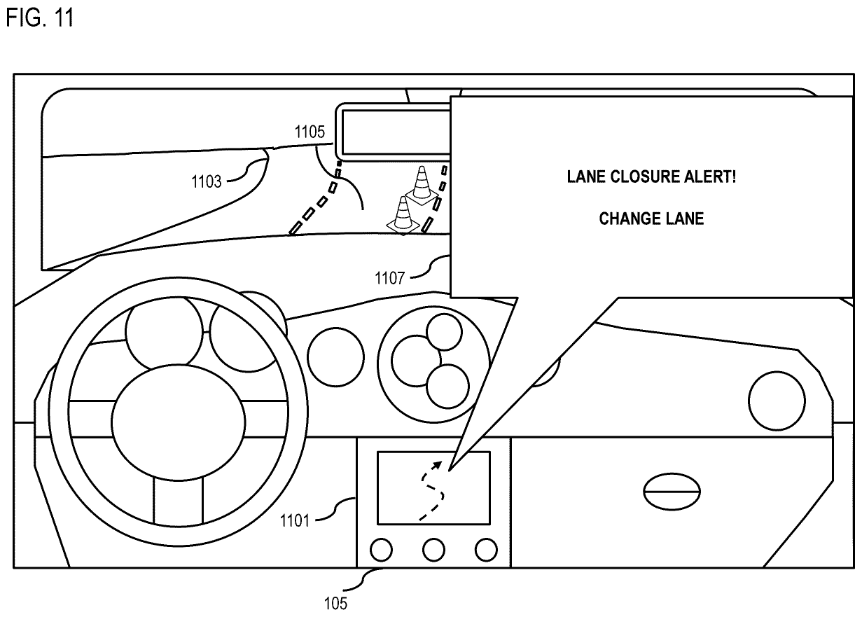

FIG. 11 is a diagram illustrating an example of using map route data filtered based on signed angle metrics, according to example embodiment(s). In FIG. 11, an example user interface (UI) 1101 (e.g., of a navigation application) capable of displaying alerts. In this example, traffic cones are placed on a lane 1105 of a road link 1103 shown UI 1101 generated for a UE 105 (e.g., a mobile device, an embedded navigation system of the vehicle 103, a server of a vehicle fleet operator, a server of a vehicle insurer, etc.). The UI 1101 also a message 1107: “Lane Closure Alert. Change lane.”

As stated above, these example use cases are provided by way of illustration and not as limitations. Other examples of non-limiting examples uses cases for using the output of the process 400 include, but is not limited to, providing vehicle speed guidance, vehicle speed handling and/or control, providing a route for navigation (e.g., via a user interface), route determination, lane level speed determination, operating the vehicle along a lane level route, route travel time determination, lane maintenance, route guidance, provision of traffic information/data, provision of lane level traffic information/data, vehicle trajectory determination and/or guidance, route and/or maneuver visualization, and/or the like.

In other embodiments, the output of the system 100 (e.g., h-value metric, h-value distributions, or map route data determined from h-value information) can be widely used in location-based applications and services. Examples of these applications and services include, but is not limited to, location-based services provided over a communication network 113 by the services platform 115, services 117 of the services platform 115, the content providers 119, application 121 of the UE 105, or any other component of the system 100.

Returning to FIG. 1, in one embodiment, the mapping platform 101 has connectivity over the communication network 113 to the services platform 115 that provides one or more services 117) (e.g., and/or sensor data collection services, and/or any other location-based/navigation services). By way of example, the services 117 may also be other third-party services and include mapping services, navigation services, traffic incident services, travel planning services, notification services, social networking services, content (e.g., audio, video, images, etc.) provisioning services, application services, storage services, contextual information determination services, location-based services, information-based services (e.g., weather, news, etc.), etc. In one embodiment, the services platform 115 uses the output (e.g., lane-level lane departure event detection and messages) of the mapping platform 101 to provide services such as navigation, mapping, other location-based services, etc.

In one embodiment, the mapping platform 101 may be a platform with multiple interconnected components. The mapping platform 101 may include multiple servers, intelligent networking devices, computing devices, components, and corresponding software for providing parametric representations of lane lines. In addition, it is noted that the mapping platform 101 may be a separate entity of the system 100, a part of the services platform 115, a part of the one or more services 117, or included within the vehicles 103 (e.g., an embedded navigation system).

In one embodiment, content providers 119 may provide content or data (e.g., including probe data, sensor data, etc.) to the mapping platform 101, the UEs 105, the applications 121, the geographic database 111, the services platform 115, the services 117, and the vehicles 103. The content provided may be any type of content, such as map content, textual content, audio content, video content, image content, etc. In one embodiment, the content providers 119 may provide content that may aid in localizing a vehicle path or trajectory on a lane of a digital map or link. In one embodiment, the content providers 119 may also store content associated with the mapping platform 101, the geographic database 111, the services platform 115, the services 117, and/or the vehicles 103. In another embodiment, the content providers 119 may manage access to a central repository of data, and offer a consistent, standard interface to data, such as a repository of the geographic database 111.

By way of example, the UEs 105 are any type of embedded system, mobile terminal, fixed terminal, or portable terminal including a built-in navigation system, a personal navigation device, mobile handset, station, unit, device, multimedia computer, multimedia tablet, Internet node, communicator, desktop computer, laptop computer, notebook computer, netbook computer, tablet computer, personal communication system (PCS) device, personal digital assistants (PDAs), audio/video player, digital camera/camcorder, positioning device, fitness device, television receiver, radio broadcast receiver, electronic book device, game device, or any combination thereof, including the accessories and peripherals of these devices, or any combination thereof. It is also contemplated that a UE 105 can support any type of interface to the user (such as “wearable” circuitry, etc.). In one embodiment, a UE 105 may be associated with a vehicle 103 (e.g., a mobile device) or be a component part of the vehicle 103 (e.g., an embedded navigation system). In one embodiment, the UEs 105 may include the mapping platform 101 to provide lane-level mapping/routing based on route identification information determined from unordered link data.

In one embodiment, as mentioned above, the vehicles 103, for instance, are part of a probe-based system for collecting probe data and/or sensor data (e.g., comprising link data) for route identification. In one embodiment, each vehicle 103 is configured to report probe data as probe points, which are individual data records collected at a point in time that records telemetry data for that point in time. In one embodiment, the probe ID can be permanent or valid for a certain period of time. In one embodiment, the probe ID is cycled, particularly for consumer-sourced data, to protect the privacy of the source.

In one embodiment, a probe point can include attributes such as: (1) probe ID, (2) longitude, (3) latitude, and (4) altitude. The list of attributes is provided by way of illustration and not limitation. Accordingly, it is contemplated that any combination of these attributes or other attributes may be recorded as a probe point. For example, attributes such as altitude (e.g., for flight capable vehicles or for tracking non-flight vehicles in the altitude domain), tilt, steering angle, wiper activation, etc. can be included and reported for a probe point. In one embodiment, the vehicles 103 may include sensors for reporting measuring and/or reporting attributes. The attributes can also be any attribute normally collected by an on-board diagnostic (OBD) system of the vehicle 103, and available through an interface to the OBD system (e.g., OBD II interface or other similar interface).

The probe points can be reported from the vehicles 103 in real-time, in batches, continuously, or at any other frequency requested by the system 100 over, for instance, the communication network 113 for processing by the mapping platform 101. The probe points also can be map matched to specific road links stored in the geographic database 111 according to the embodiments described herein. In one embodiment, the system 100 (e.g., via the mapping platform 101) can generate probe traces (e.g., vehicle paths or trajectories) from the probe points for an individual probe so that the probe traces represent a travel trajectory or vehicle path of the probe through the road network (e.g., examples of link data).

In one embodiment, as previously stated, the vehicles 103 are configured with various sensors (e.g., vehicle sensors) for generating or collecting probe data, sensor data, related geographic/map data, etc. In one embodiment, the sensed data represents sensor data associated with a geographic location or coordinates at which the sensor data was collected. In one embodiment, the probe data (e.g., stored in the geographic database 111) includes location probes collected by one or more vehicle sensors. By way of example, the vehicle sensors may include a RADAR system, a LiDAR system, global positioning sensor for gathering location data (e.g., GPS), a network detection sensor for detecting wireless signals or receivers for different short-range communications (e.g., Bluetooth, Wi-Fi, Li-Fi, near field communication (NFC) etc.), temporal information sensors, a camera/imaging sensor for gathering image data, an audio recorder for gathering audio data, velocity sensors mounted on a steering wheel of the vehicles 103, switch sensors for determining whether one or more vehicle switches are engaged, and the like. Though depicted as automobiles, it is contemplated the vehicles 103 can be any type of vehicle manned or unmanned (e.g., cars, trucks, buses, vans, motorcycles, scooters, drones, etc.) that travel through road segments of a road network.

Other examples of sensors of the vehicle 103 may include light sensors, orientation sensors augmented with height sensors and acceleration sensor (e.g., an accelerometer can measure acceleration and can be used to determine orientation of the vehicle), tilt sensors to detect the degree of incline or decline of the vehicle 103 along a path of travel (e.g., while on a hill or a cliff), moisture sensors, pressure sensors, etc. In a further example embodiment, sensors about the perimeter of the vehicle 103 may detect the relative distance of the vehicle 103 from a physical divider, a lane line of a link or roadway (e.g., vehicle path 201), the presence of other vehicles, pedestrians, traffic lights, potholes and any other objects, or a combination thereof. In one scenario, the vehicle sensors may detect weather data, traffic information, or a combination thereof. In one embodiment, the vehicles 103 may include GPS or other satellite-based receivers to obtain geographic coordinates from satellites 107 for determining current location and time. Further, the location can be determined by visual odometry, triangulation systems such as A-GPS, Cell of Origin, or other location extrapolation technologies.

In one embodiment, the UEs 105 may also be configured with various sensors (not shown for illustrative convenience) for acquiring and/or generating probe data and/or sensor data associated with a vehicle 103, a driver, other vehicles, conditions regarding the driving environment or roadway, etc. For example, such sensors may be used as GPS receivers for interacting with the one or more satellites 107 to determine and track the current speed, position, and location of a vehicle 103 travelling along a link or roadway. In addition, the sensors may gather tilt data (e.g., a degree of incline or decline of the vehicle during travel), motion data, light data, sound data, image data, weather data, temporal data and other data associated with the vehicles 103 and/or UEs 105. Still further, the sensors may detect local or transient network and/or wireless signals, such as those transmitted by nearby devices during navigation of a vehicle along a roadway (Li-Fi, near field communication (NFC)) etc.

It is noted therefore that the above described data may be transmitted via the communication network 113 as probe data or link data (e.g., GPS point data) according to any known wireless communication protocols. For example, each UE 105, application 121, user, and/or vehicle 103 may be assigned a unique probe identifier (probe ID) for use in reporting or transmitting said probe data collected by the vehicles 103 and/or UEs 105. In one embodiment, each vehicle 103 and/or UE 105 is configured to report probe data as probe points, which are individual data records collected at a point in time that records telemetry data.

In one embodiment, the mapping platform 101 retrieves aggregated probe points gathered and/or generated by the vehicle sensors and/or the UE 105 resulting from the travel of the UEs 105 and/or vehicles 103 on a road segment of a road network. In one instance, the geographic database 111 stores a plurality of probe points and/or trajectories (e.g., link data) generated by different vehicle sensors, UEs 105, applications 121, vehicles 103, etc. over a period while traveling in a monitored area. A time sequence of probe points specifies a trajectory—i.e., a path traversed by a UE 105, application 121, vehicle 103, etc. over the period.

In one embodiment, the communication network 113 of the system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, 5G New Radio networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

By way of example, the vehicles 103, vehicle sensors, mapping platform 101, UEs 105, applications 121, services platform 115, services 117, and/or content providers 119 communicate with each other and other components of the system 100 using well known, new or still developing protocols. In this context, a protocol includes a set of rules defining how the network nodes within the communication network 113 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

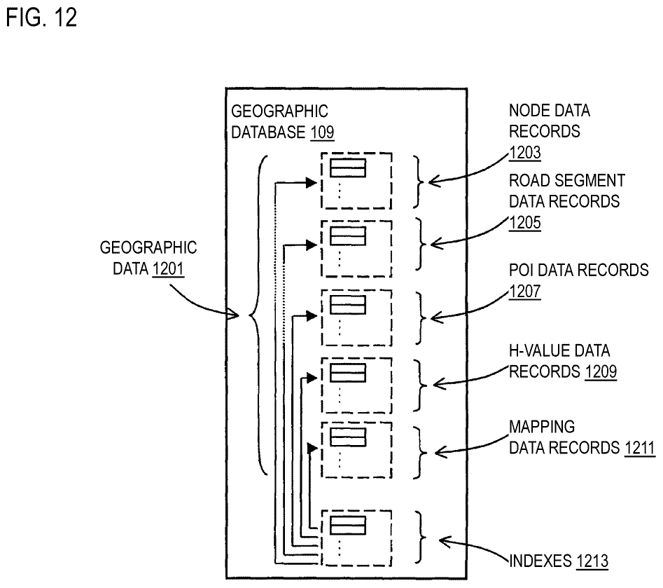

FIG. 12 is a diagram of a geographic database (such as the database 111), according to one embodiment. In one embodiment, the geographic database 111 includes geographic data 1201 used for (or configured to be compiled to be used for) mapping and/or navigation-related services, such as for video odometry based on the parametric representation of lanes include, e.g., encoding and/or decoding parametric representations into lane lines. In one embodiment, the geographic database 111 include high resolution or high definition (HD) mapping data that provide centimeter-level or better accuracy of map features. For example, the geographic database 111 can be based on Light Detection and Ranging (LiDAR) or equivalent technology to collect very large numbers of 3D points depending on the context (e.g., a single street/scene, a country, etc.) and model road surfaces and other map features down to the number lanes and their widths. In one embodiment, the mapping data (e.g., mapping data records 1211) capture and store details such as the slope and curvature of the road, lane markings, roadside objects such as signposts, including what the signage denotes. By way of example, the mapping data enable highly automated vehicles to precisely localize themselves on the road.

In one embodiment, geographic features (e.g., two-dimensional or three-dimensional features) are represented using polygons (e.g., two-dimensional features) or polygon extrusions (e.g., three-dimensional features). For example, the edges of the polygons correspond to the boundaries or edges of the respective geographic feature. In the case of a building, a two-dimensional polygon can be used to represent a footprint of the building, and a three-dimensional polygon extrusion can be used to represent the three-dimensional surfaces of the building. It is contemplated that although various embodiments are discussed with respect to two-dimensional polygons, it is contemplated that the embodiments are also applicable to three-dimensional polygon extrusions. Accordingly, the terms polygons and polygon extrusions as used herein can be used interchangeably.

In one embodiment, the following terminology applies to the representation of geographic features in the geographic database 111.

“Node”—A point that terminates a link.

“Line segment”—A straight line connecting two points.

“Link” (or “edge”)—A contiguous, non-branching string of one or more line segments terminating in a node at each end.

“Shape point”—A point along a link between two nodes (e.g., used to alter a shape of the link without defining new nodes).

“Oriented link”—A link that has a starting node (referred to as the “reference node”) and an ending node (referred to as the “non reference node”).

“Simple polygon”—An interior area of an outer boundary formed by a string of oriented links that begins and ends in one node. In one embodiment, a simple polygon does not cross itself.

“Polygon”—An area bounded by an outer boundary and none or at least one interior boundary (e.g., a hole or island). In one embodiment, a polygon is constructed from one outer simple polygon and none or at least one inner simple polygon. A polygon is simple if it just consists of one simple polygon, or complex if it has at least one inner simple polygon.

In one embodiment, the geographic database 111 follows certain conventions. For example, links do not cross themselves and do not cross each other except at a node. Also, there are no duplicated shape points, nodes, or links. Two links that connect each other have a common node. In the geographic database 111, overlapping geographic features are represented by overlapping polygons. When polygons overlap, the boundary of one polygon crosses the boundary of the other polygon. In the geographic database 111, the location at which the boundary of one polygon intersects they boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

As shown, the geographic database 111 includes node data records 1203, road segment or link data records 1205, POI data records 1207, h-value data records 1209, mapping data records 1211, and indexes 1213, for example. More, fewer or different data records can be provided. In one embodiment, additional data records (not shown) can include cartographic (“carto”) data records, routing data, and maneuver data. In one embodiment, the indexes 1213 may improve the speed of data retrieval operations in the geographic database 111. In one embodiment, the indexes 1213 may be used to quickly locate data without having to search every row in the geographic database 111 every time it is accessed. For example, in one embodiment, the indexes 1213 can be a spatial index of the polygon points associated with stored feature polygons.

In exemplary embodiments, the road segment data records 1205 are links or segments representing roads, streets, or paths, as can be used in the calculated route or recorded route information for determination of one or more personalized routes. The node data records 1203 are end points (such as intersections) corresponding to the respective links or segments of the road segment data records 1205. The road link data records 1205 and the node data records 1203 represent a road network, such as used by vehicles, cars, and/or other entities. Alternatively, the geographic database 111 can contain path segment and node data records or other data that represent pedestrian paths or areas in addition to or instead of the vehicle road record data, for example.

The road/link segments and nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database 111 can include data about the POIs and their respective locations in the POI data records 1207. The geographic database 111 can also include data about places, such as cities, towns, or other communities, and other geographic features, such as bodies of water, mountain ranges, etc. Such place or feature data can be part of the POI data records 1207 or can be associated with POIs or POI data records 1207 (such as a data point used for displaying or representing a position of a city). In one embodiment, certain attributes, such as lane marking data records, mapping data records and/or other attributes can be features or layers associated with the link-node structure of the database.

In one embodiment, the geographic database 111 can also include h-value data records 1209 for storing h-value metrics, historical and real-time h-value distribution data, training data, prediction models, annotated observations, computed featured distributions, sampling probabilities, and/or any other data generated or used by the system 100 according to the various embodiments described herein. By way of example, the h-value data records 1209 can be associated with one or more of the node records 1203, road segment records 1205, and/or POI data records 1207 to support localization or visual odometry based on the features stored therein and the corresponding estimated quality of the features. In this way, the h-value data records 1209 can also be associated with or used to classify the characteristics or metadata of the corresponding records 1203, 1205, and/or 1207.

In one embodiment, as discussed above, the mapping data records 1211 model road surfaces and other map features to centimeter-level or better accuracy. The mapping data records 1211 also include lane models that provide the precise lane geometry with lane boundaries, as well as rich attributes of the lane models. These rich attributes include, but are not limited to, lane traversal information, lane types, lane marking types, lane level speed limit information, and/or the like. In one embodiment, the mapping data records 1211 are divided into spatial partitions of varying sizes to provide mapping data to vehicles 103 and other end user devices with near real-time speed without overloading the available resources of the vehicles 103 and/or devices (e.g., computational, memory, bandwidth, etc. resources).

In one embodiment, the mapping data records 1211 are created from high-resolution 3D mesh or point-cloud data generated, for instance, from LiDAR-equipped vehicles. The 3D mesh or point-cloud data are processed to create 3D representations of a street or geographic environment at centimeter-level accuracy for storage in the mapping data records 1211.

In one embodiment, the mapping data records 1211 also include real-time sensor data collected from probe vehicles in the field. The real-time sensor data, for instance, integrates real-time traffic information, weather, and road conditions (e.g., potholes, road friction, road wear, etc.) with highly detailed 3D representations of street and geographic features to provide precise real-time also at centimeter-level accuracy. Other sensor data can include vehicle telemetry or operational data such as windshield wiper activation state, braking state, steering angle, accelerator position, and/or the like.

In one embodiment, the geographic database 111 can be maintained by the content providers 119 in association with the services platform 117 (e.g., a map developer). The map developer can collect geographic data to generate and enhance the geographic database 111. There can be different ways used by the map developer to collect data. These ways can include obtaining data from other sources, such as municipalities or respective geographic authorities. In addition, the map developer can employ field personnel to travel by vehicle (e.g., vehicles 103 and/or UEs 105) along roads throughout the geographic region to observe features and/or record information about them, for example. Also, remote sensing, such as aerial or satellite photography, can be used.

The geographic database 111 can be a master geographic database stored in a format that facilitates updating, maintenance, and development. For example, the master geographic database or data in the master geographic database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by a vehicle 103 or a UE 105, for example. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

The processes described herein for providing a signed angle metric for map-matching based on probe data may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

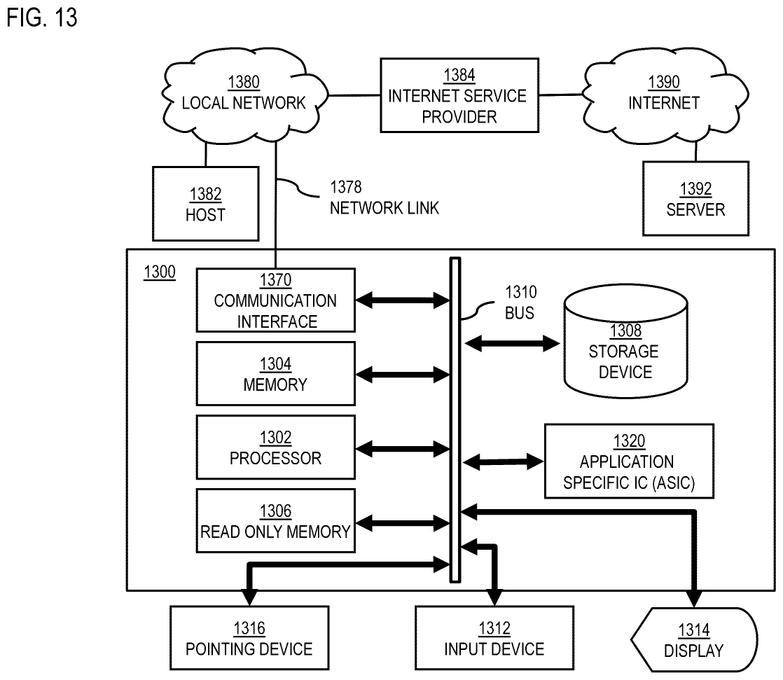

FIG. 13 illustrates a computer system 1300 upon which an embodiment of the invention may be implemented. Computer system 1300 is programmed (e.g., via computer program code or instructions) to provide a signed angle metric for map-matching based on probe data as described herein and includes a communication mechanism such as a bus 1310 for passing information between other internal and external components of the computer system 1300. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 1310 includes one or more parallel conductors of information so that information is transferred quickly among devices coupled to the bus 1310. One or more processors 1302 for processing information are coupled with the bus 1310.

A processor 1302 performs a set of operations on information as specified by computer program code related to providing a signed angle metric for map-matching based on probe data. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1310 and placing information on the bus 1310. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1302, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 1300 also includes a memory 1304 coupled to bus 1310. The memory 1304, such as a random access memory (RAM) or other dynamic storage device, stores information including processor instructions for providing a signed angle metric for map-matching based on probe data. Dynamic memory allows information stored therein to be changed by the computer system 1300. RAM allows a unit of information stored at a location called a memory address to be stored and retrieved independently of information at neighboring addresses. The memory 1304 is also used by the processor 1302 to store temporary values during execution of processor instructions. The computer system 1300 also includes a read only memory (ROM) 1306 or other static storage device coupled to the bus 1310 for storing static information, including instructions, that is not changed by the computer system 1300. Some memory is composed of volatile storage that loses the information stored thereon when power is lost. Also coupled to bus 1310 is a non-volatile (persistent) storage device 1308, such as a magnetic disk, optical disk or flash card, for storing information, including instructions, that persists even when the computer system 1300 is turned off or otherwise loses power.

Information, including instructions for providing a signed angle metric for map-matching based on probe data, is provided to the bus 1310 for use by the processor from an external input device 1312, such as a keyboard containing alphanumeric keys operated by a human user, or a sensor. A sensor detects conditions in its vicinity and transforms those detections into physical expression compatible with the measurable phenomenon used to represent information in computer system 1300. Other external devices coupled to bus 1310, used primarily for interacting with humans, include a display device 1314, such as a cathode ray tube (CRT) or a liquid crystal display (LCD), or plasma screen or printer for presenting text or images, and a pointing device 1316, such as a mouse or a trackball or cursor direction keys, or motion sensor, for controlling a position of a small cursor image presented on the display 1314 and issuing commands associated with graphical elements presented on the display 1314. In some embodiments, for example, in embodiments in which the computer system 1300 performs all functions automatically without human input, one or more of external input device 1312, display device 1314 and pointing device 1316 is omitted.

In the illustrated embodiment, special purpose hardware, such as an application specific integrated circuit (ASIC) 1320, is coupled to bus 1310. The special purpose hardware is configured to perform operations not performed by processor 1302 quickly enough for special purposes. Examples of application specific ICs include graphics accelerator cards for generating images for display 1314, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1300 also includes one or more instances of a communications interface 1370 coupled to bus 1310. Communication interface 1370 provides a one-way or two-way communication coupling to a variety of external devices that operate with their own processors, such as printers, scanners and external disks. In general the coupling is with a network link 1378 that is connected to a local network 1380 to which a variety of external devices with their own processors are connected. For example, communication interface 1370 may be a parallel port or a serial port or a universal serial bus (USB) port on a personal computer. In some embodiments, communications interface 1370 is an integrated services digital network (ISDN) card or a digital subscriber line (DSL) card or a telephone modem that provides an information communication connection to a corresponding type of telephone line. In some embodiments, a communication interface 1370 is a cable modem that converts signals on bus 1310 into signals for a communication connection over a coaxial cable or into optical signals for a communication connection over a fiber optic cable. As another example, communications interface 1370 may be a local area network (LAN) card to provide a data communication connection to a compatible LAN, such as Ethernet. Wireless links may also be implemented. For wireless links, the communications interface 1370 sends or receives or both sends and receives electrical, acoustic or electromagnetic signals, including infrared and optical signals, that carry information streams, such as digital data. For example, in wireless handheld devices, such as mobile telephones like cell phones, the communications interface 1370 includes a radio band electromagnetic transmitter and receiver called a radio transceiver. In certain embodiments, the communications interface 1370 enables connection to the communication network 105 for providing a signed angle metric for map-matching based on probe data to the UE 105.

The term computer-readable medium is used herein to refer to any medium that participates in providing information to processor 1302, including instructions for execution. Such a medium may take many forms, including, but not limited to, non-volatile media, volatile media and transmission media. Non-volatile media include, for example, optical or magnetic disks, such as storage device 1308. Volatile media include, for example, dynamic memory 1304. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

Network link 1378 typically provides information communication using transmission media through one or more networks to other devices that use or process the information. For example, network link 1378 may provide a connection through local network 1380 to a host computer 1382 or to equipment 1384 operated by an Internet Service Provider (ISP). ISP equipment 1384 in turn provides data communication services through the public, world-wide packet-switching communication network of networks now commonly referred to as the Internet 1390.

A computer called a server host 1392 connected to the Internet hosts a process that provides a service in response to information received over the Internet. For example, server host 1392 hosts a process that provides information representing video data for presentation at display 1314. It is contemplated that the components of system can be deployed in various configurations within other computer systems, e.g., host 1382 and server 1392.

FIG. 14 illustrates a chip set 1400 upon which an embodiment of the invention may be implemented. Chip set 1400 is programmed to provide a signed angle metric for map-matching based on probe data as described herein and includes, for instance, the processor and memory components described with respect to FIG. 13 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 1400 includes a communication mechanism such as a bus 1401 for passing information among the components of the chip set 1400. A processor 1403 has connectivity to the bus 1401 to execute instructions and process information stored in, for example, a memory 1405. The processor 1403 may include one or more processing cores with each core configured to perform independently. A multi-core processor enables multiprocessing within a single physical package. Examples of a multi-core processor include two, four, eight, or greater numbers of processing cores. Alternatively or in addition, the processor 1403 may include one or more microprocessors configured in tandem via the bus 1401 to enable independent execution of instructions, pipelining, and multithreading. The processor 1403 may also be accompanied with one or more specialized components to perform certain processing functions and tasks such as one or more digital signal processors (DSP) 1407, or one or more application-specific integrated circuits (ASIC) 1409. A DSP 1407 typically is configured to process real-world signals (e.g., sound) in real time independently of the processor 1403. Similarly, an ASIC 1409 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1403 and accompanying components have connectivity to the memory 1405 via the bus 1401. The memory 1405 includes both dynamic memory (e.g., RAM, magnetic disk, writable optical disk, etc.) and static memory (e.g., ROM, CD-ROM, etc.) for storing executable instructions that when executed perform the inventive steps described herein to provide a signed angle metric for map-matching based on probe data. The memory 1405 also stores the data associated with or generated by the execution of the inventive steps.

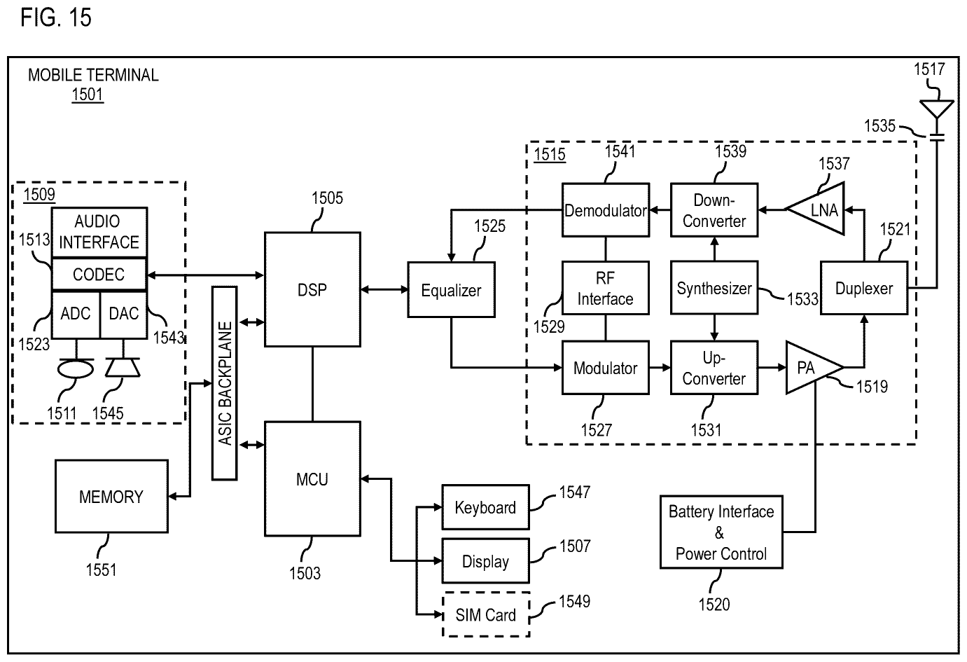

FIG. 15 is a diagram of exemplary components of a mobile terminal 1501 (e.g., handset or vehicle or part thereof) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 1503, a Digital Signal Processor (DSP) 1505, and a receiver/transmitter unit including a microphone gain control unit and a speaker gain control unit. A main display unit 1507 provides a display to the user in support of various applications and mobile station functions that offer automatic contact matching. An audio function circuitry 1509 includes a microphone 1511 and microphone amplifier that amplifies the speech signal output from the microphone 1511. The amplified speech signal output from the microphone 1511 is fed to a coder/decoder (CODEC) 1513.

A radio section 1515 amplifies power and converts frequency in order to communicate with a base station, which is included in a mobile communication system, via antenna 1517. The power amplifier (PA) 1519 and the transmitter/modulation circuitry are operationally responsive to the MCU 1503, with an output from the PA 1519 coupled to the duplexer 1521 or circulator or antenna switch, as known in the art. The PA 1519 also couples to a battery interface and power control unit 1520.

In use, a user of mobile station 1501 speaks into the microphone 1511 and his or her voice along with any detected background noise is converted into an analog voltage. The analog voltage is then converted into a digital signal through the Analog to Digital Converter (ADC) 1523. The control unit 1503 routes the digital signal into the DSP 1505 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wireless fidelity (WiFi), satellite, and the like.

The encoded signals are then routed to an equalizer 1525 for compensation of any frequency-dependent impairments that occur during transmission though the air such as phase and amplitude distortion. After equalizing the bit stream, the modulator 1527 combines the signal with a RF signal generated in the RF interface 1529. The modulator 1527 generates a sine wave by way of frequency or phase modulation. In order to prepare the signal for transmission, an up-converter 1531 combines the sine wave output from the modulator 1527 with another sine wave generated by a synthesizer 1533 to achieve the desired frequency of transmission. The signal is then sent through a PA 1519 to increase the signal to an appropriate power level. In practical systems, the PA 1519 acts as a variable gain amplifier whose gain is controlled by the DSP 1505 from information received from a network base station. The signal is then filtered within the duplexer 1521 and optionally sent to an antenna coupler 1535 to match impedances to provide maximum power transfer. Finally, the signal is transmitted via antenna 1517 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 1501 are received via antenna 1517 and immediately amplified by a low noise amplifier (LNA) 1537. A down-converter 1539 lowers the carrier frequency while the demodulator 1541 strips away the RF leaving only a digital bit stream. The signal then goes through the equalizer 1525 and is processed by the DSP 1505. A Digital to Analog Converter (DAC) 1543 converts the signal and the resulting output is transmitted to the user through the speaker 1545, all under control of a Main Control Unit (MCU) 1503?which can be implemented as a Central Processing Unit (CPU) (not shown).

The MCU 1503 receives various signals including input signals from the keyboard 1547. The keyboard 1547 and/or the MCU 1503 in combination with other user input components (e.g., the microphone 1511) comprise a user interface circuitry for managing user input. The MCU 1503 runs a user interface software to facilitate user control of at least some functions of the mobile station 1501 to provide a signed angle metric for map-matching based on probe data. The MCU 1503 also delivers a display command and a switch command to the display 1507 and to the speech output switching controller, respectively. Further, the MCU 1503 exchanges information with the DSP 1505 and can access an optionally incorporated SIM card 1549 and a memory 1551. In addition, the MCU 1503 executes various control functions required of the station. The DSP 1505 may, depending upon the implementation, perform any of a variety of conventional digital processing functions on the voice signals. Additionally, DSP 1505 determines the background noise level of the local environment from the signals detected by microphone 1511 and sets the gain of microphone 1511 to a level selected to compensate for the natural tendency of the user of the mobile station 1501.

The CODEC 1513 includes the ADC 1523 and DAC 1543. The memory 1551 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory device 1551 may be, but not limited to, a single memory, CD, DVD, ROM, RAM, EEPROM, optical storage, or any other non-volatile or non-transitory storage medium capable of storing digital data.

An optionally incorporated SIM card 1549 carries, for instance, important information, such as the cellular phone number, the carrier supplying service, subscription details, and security information. The SIM card 1549 serves primarily to identify the mobile station 1501 on a radio network. The card 1549 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
processing probe data collected from a probe device to determine a probe heading, wherein the probe heading indicates a direction of travel of the probe device;
matching the probe data to a road link;
determining a link heading of the road link, wherein the link heading indicates a direction along which the road link is oriented;
computing a magnitude of an h-value metric based on a difference between the probe heading and the link heading;
determining a sign of the h-value metric based on a position of the probe heading relative to the link heading, wherein the sign is either a negative sign or a positive sign; and
providing the h-value metric comprising a combination of the magnitude and the sign as an output.

2. The method of claim 1, wherein the sign of the h-value metric is the negative sign based on determining that the position of the probe heading is to a left of the link heading, and wherein the sign of the h-value metric is the positive sign based determining that the position of the probe heading is to a right of the link heading.

3. The method of claim 1, further comprising:
filtering the probe data, determining that the probe data is a mismatch or an outlier for the road link, or a combination thereof based on comparing the h-value metric to a value range threshold.

4. The method of claim 3, further comprising:
performing map matching based on the filtering of the probe data, the determining that the probe data is the mismatch or the outlier, or a combination thereof.

5. The method of claim 1, further comprising:
processing historical probe data associated with the road link to determine a distribution of historical h-value metrics for the road link; and
storing the distribution of the historical h-value metrics, the historical h-value metrics, or a combination thereof as a historical artifact data record of a geographic database.

6. The method of claim 5, wherein the distribution of the historical of the historical h-value metrics is determined with respect to a sliding time window of a predetermined time duration.

7. The method of claim 1, further comprising:
processing real-time probe data associated with the road link to determine a distribution of real-time h-value metrics for the road link.

8. The method of claim 7, further comprising:
storing the distribution of the real-time h-value metrics as a real-time artifact data record of a geographic database.

9. The method of claim 7, further comprising:
detecting that the distribution of the real-time h-value metrics decomposes into a plurality of clusters; and
determining a traffic incident on the road link based on the plurality of clusters.

10. The method of claim 9, wherein the traffic incident relates to a lane closure or a lane obstruction on at least one lane of the road link.

11. The method of claim 9, wherein the plurality of clusters is determined using a multidimensional clustering algorithm.

12. The method of claim 1, further comprising:
generating a probe heading unit vector based on the probe heading; and
generating a link heading unit vector based on the link heading,
wherein the magnitude of the h-value is computed using a dot product of the probe heading unit vector and the link heading unit vector; and
wherein the sign of the h-value is determined using a cross product of the probe heading unit vector and the link heading unit vector.

13. An apparatus comprising:
at least one processor; and
at least one memory including computer program code for one or more programs,
the at least one memory and the computer program code configured to, with the at least one processor, cause the apparatus to perform at least the following,
process probe data collected from a probe device to determine a probe heading, wherein the probe heading indicates a direction of travel of the probe device;
match the probe data to a road link;
determine a link heading of the road link, wherein the link heading indicates a direction along which the road link is oriented;
compute a magnitude of an h-value metric based on a difference between the probe heading and the link heading;
determine a sign of the h-value metric based on a position of the probe heading relative to the link heading, wherein the sign is either a negative sign or a positive sign; and
provide the h-value metric comprising a combination of the magnitude and the sign as an output.

14. The apparatus of claim 13, wherein the sign of the h-value metric is the negative sign based on determining that the position of the probe heading is to a left of the link heading, and wherein the sign of the h-value metric is the positive sign based determining that the position of the probe heading is to a right of the link heading.

15. The apparatus of claim 13, wherein the apparatus is further caused to:
filter the probe data, determining that the probe data is a mismatch or an outlier for the road link, or a combination thereof based on comparing the h-value metric to a value range threshold.

16. The apparatus of claim 15, wherein the apparatus is further caused to:
perform map matching based on the filtering of the probe data, the determining that the probe data is the mismatch or the outlier, or a combination thereof.

17. A non-transitory computer-readable storage medium, carrying one or more sequences of one or more instructions which, when executed by one or more processors, cause an apparatus to at least perform the following steps:
processing probe data collected from a probe device to determine a probe heading, wherein the probe heading indicates a direction of travel of the probe device;
matching the probe data to a road link;
determining a link heading of the road link, wherein the link heading indicates a direction along which the road link is oriented;
computing a magnitude of an h-value metric based on a difference between the probe heading and the link heading;
determining a sign of the h-value metric based on a position of the probe heading relative to the link heading, wherein the sign is either a negative sign or a positive sign; and
providing the h-value metric comprising a combination of the magnitude and the sign as an output.

18. The non-transitory computer-readable storage medium of claim 17, wherein the sign of the h-value metric is the negative sign based on determining that the position of the probe heading is to a left of the link heading, and wherein the sign of the h-value metric is the positive sign based determining that the position of the probe heading is to a right of the link heading.

19. The non-transitory computer-readable storage medium of claim 17, wherein the apparatus is caused to further perform:
filtering the probe data, determining that the probe data is a mismatch or an outlier for the road link, or a combination thereof based on comparing the h-value metric to a value range threshold.

20. The non-transitory computer-readable storage medium of claim 19, wherein the apparatus is caused to further perform:
performing map matching based on the filtering of the probe data, the determining that the probe data is the mismatch or the outlier, or a combination thereof.
